(19) United States
(12) Patent Application Publication
(10) Pub. No.: US 2025/0349071 A1
(43) Pub. Date: Nov. 13, 2025

(54) IMAGE RENDERING METHOD, ELECTRONIC DEVICE AND STORAGE MEDIUM

(71) Applicant: Beijing Zitiao Network Technology Co., Ltd., Beijing (CN)

(72) Inventors: Ligang LI, Beijing (CN); Yunlong CUI, Beijing (CN); Mingxuan LI, Beijing (CN)

(21) Appl. No.: 19/203,993

(22) Filed: May 9, 2025

(30) Foreign Application Priority Data
May 11, 2024 (CN) 202410584976.1

(51) Int. Cl. G06T 17/00; G06F 3/01

(52) U.S. Cl. CPC G06T 17/00; G06F 3/011

(57) ABSTRACT

A n image rendering method, an electronic device and a storage medium. The method includes: determining whether a preset condition is met for rendering a first frame, the preset condition includes that a change of a current target pose of a user relative to a target pose corresponding to a previous frame of the first frame is smaller than a threshold, and a current scene content is unchanged relative to a scene content corresponding to the previous frame; in response to determining that the preset condition is met, skipping rendering the first frame, and performing transformation processing on the previous frame based on an updated target pose to obtain an output frame for display; displaying the output frame through the display generation component.

### CROSS REFERENCE

The present application claims priority of Chinese Patent Application No. 202410584976.1, filed on May 11, 2024, the disclosure of which is incorporated herein by reference in its entirety as part of the present application.

### TECHNICAL FIELD

The present disclosure relates to the technical field of computers, and specifically relates to an image rendering method and apparatus, an electronic device and a storage medium.

### BACKGROUND

Extended reality (XR) is a general term for Augmented reality (AR), Virtual reality (VR) and Mixed reality (MR), which aims to combine a physical world with virtual to provide users with three-dimensional scenes for human-computer interaction. Images displayed by an extended reality apparatus may cause change in viewing angle due to changes of the user pose, so a rendering strategy used in the related extended reality technology is to render each frame to keep pace with the screen refresh rate. This mode leads to high power consumption of the apparatus and reduces the battery life of the extended reality apparatus. In particular, in some use scenes, users often remain stationary or have little amplitude of motion, so rendering each frame may incur unnecessary power consumption.

### SUMMARY

The contents of the summary are provided in order to present the concepts in a brief form, which will be described in detail in the specific embodiments at a later stage. The content of the summary is not intended to identify the key features or necessary features of the claimed technical solution, nor is it intended to limit the scope of the claimed technical solution.

In a first aspect, according to one or more embodiments of the present disclosure, there is provided an image rendering method, including:
determining whether a preset condition is met for rendering a first frame, wherein the preset condition includes that a change of a current target pose of a user relative to a target pose corresponding to a previous frame of the first frame is smaller than a threshold, and a current scene content is unchanged relative to a scene content corresponding to the previous frame;
in response to determining that the preset condition is met, skipping rendering the first frame, and performing transformation processing on the previous frame based on an updated target pose to obtain an output frame for display;
displaying the output frame through the display generation component.

In a second aspect, according to one or more embodiments of the present disclosure, there is provided an image rendering apparatus, including:
a determination unit, configured to: determine whether a preset condition is met for rendering a first frame, wherein the preset condition includes that a change of a current target pose of a user relative to a target pose corresponding to a previous frame of the first frame is smaller than a threshold, and a current scene content is unchanged relative to a scene content corresponding to the previous frame;
an image processing unit, configured to: determining that the preset condition is met, skip rendering the first frame, and performing transformation processing on the previous frame based on an updated target pose to obtain an output frame for display;
a display unit, configured to display the output frame through a display generation component.

In a third aspect, according to one or more embodiments of the present disclosure, there is provided an electronic device, including: at least one memory and at least one processor, wherein the memory is configured to store program instructions, and the program instructions, when executed by the processor, cause the processor to execute the image rendering method according to one or more embodiments of the present disclosure.

In a fourth aspect, according to one or more embodiments of the present disclosure, there is provided a non-transitory computer-readable storage medium, including: wherein the non-transitory computer-readable storage medium is configured to store program instructions, and the program instructions, when executed by a processor, cause the processor to execute the image rendering method according to one or more embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flow schematic diagram of an image rendering method provided by one embodiment of the present disclosure;

FIG. 2 is an optional schematic diagram of a virtual field-of-view of an extended reality device provided by one embodiment of the present disclosure;

FIG. 3 is a flow schematic diagram of an image rendering method provided by another embodiment of the present disclosure;

FIG. 4 is a structure schematic diagram of an image rendering apparatus provided by one embodiment of the present disclosure; and

FIG. 5 is a structure schematic diagram of an electronic device provided by one embodiment of the present disclosure.

### DETAILED DESCRIPTION

Embodiments of the present disclosure are described in more detail below with reference to the drawings. Although certain embodiments of the present disclosure are illustrated by the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. The term “in response to” and related terms refer to that one signal or event is affected by another to a certain extent, but not necessarily completely or directly. In response to that an event x occurs “in response” to an event y, x may respond directly or indirectly to y. For example, the occurrence of y may eventually lead to the occurrence of x, but there may be other intermediate events and/or conditions. In other cases, y may not necessarily cause x, and x may occur even if y has not yet occurred. In addition, the term “in response to” can also mean “at least partially in response to”.

The term “determination” broadly encompasses a wide variety of actions, including acquisition, calculus, computation, processing, derivation, investigation, search (e.g., search in a table, database, or other data structure), discovery, and similar actions, or as receiving (e.g., receiving information), accessing (e.g., accessing data in a memory), and similar actions, as well as parsing, selecting, picking, building, and similar actions. The relevant definitions of other terms are given in the following descriptions.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

For the objective of the present disclosure, the phrases “A and/or B” mean (A), (B) or (A and B).

The names of messages or information exchanged among a plurality of apparatuses in the embodiments of present disclosure are for illustrative purposes only and are not intended to limit the scope of such messages or information.

It is to be noted that in the present disclosure, a step of acquiring personal data of a user is carried out with the authorization of the user, for example, in response to the receiving of an active request of the user, a prompt message will be transmitted to the user to clearly inform the user that the operation requested to be executed may acquire and use the personal information of the user. Thus, the user can choose whether to provide personal information to software or hardware such as electronic devices, applications, servers, or storage mediums that perform the operation of the technical solution of the present disclosure according to the prompt message. A s an optional but non-limited implementation, in response to the receiving of the active request of the user, the way to transmit the prompt message to the user can be a way of a pop-up window, and the pop-up window can present the prompt message in a form of text. In addition, the pop-up window can also carry a selection control for the user to select whether to “agree” or “disagree” to provide personal information to the electronic device. It is to be understood that the above-mentioned process of informing and acquiring the user authorization are only indicative and do not limit the implementation of the present disclosure, and other methods that meet the relevant laws and regulations can also be applied to the implementation of the present disclosure. It is to be understood that the data involved in the technical solution (including but not limited to the data itself, and the acquisition or use of data) shall comply with the requirements of relevant laws and regulations and relevant provisions.

An extended reality device recorded in the embodiment of the present may include but is not limited to the following types:

Computer-side extended reality device: related computation and data output of an extended reality function are performed on a PC, and the external computer-side augmented reality device realizes an extended reality effect by utilizing the data outputted on the PC.

Mobile extended reality device: it supports to arrange a mobile terminal (such as a smart phone) in various modes (such as a head-mounted display provided with a special clamping groove); it is connected to the mobile terminal in a wired or wireless mode, the mobile terminal carries out related computation of the extended reality function and outputs data to the mobile augmented reality device, for example, an extended reality video is watched through an APP of the mobile terminal.

All-in-one extended reality device: it is provided with a processor that is configured to carry out related computation of the extended reality function, so it has independent extended reality input and output functions, does not need to be connected to the PC or the mobile terminal, and is high in use freedom degree.

Definitely, the implementation form of the extended reality device is not limited to above, and it can be further miniaturized or enlarged according to needs.

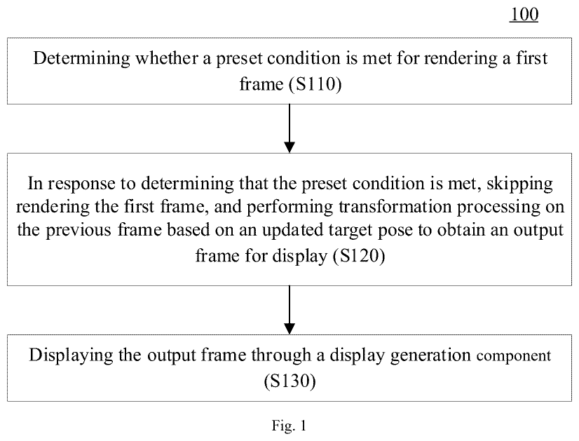

With reference to FIG. 1, it shows a flowchart of an image rendering method 100 provided by one embodiment of the present disclosure. In some embodiments, the method 100 is executed through an electronic device (such as a head-mounted display), and the electronic device can be in communication with a display generation component (such as a display screen) and one or more sensing devices (such as a head tracking device, an eye tracking device, a hand tracking device, a camera or other sensing devices). In some embodiments, the display generation component and the sensing devices can be integrated on the electronic device.

The method 100 includes step S110-step S130:

Step S110: determining whether a first frame meets a preset condition for rendering the first frame.

The first frame may represent a view of a scene at a first time point in a first viewpoint. Exemplarily, the first frame may be a current frame, namely a frame to be rendered currently.

In some embodiments, the “for rendering a first frame” may refer to a moment within a time period from triggering of an instruction or signal for rendering the first frame to actual rendering of the first frame. In the embodiment, after the instruction or signal for rendering the first frame is triggered, the electronic device does not directly render the first frame but determines whether the preset condition is met currently or not.

The preset condition includes that a change of a current target pose of the user relative to a target pose corresponding to a previous frame of the first frame is smaller than a threshold, and a current scene content is unchanged relative to a scene content corresponding to the previous frame. The current scene content may be a scene content generated by a current application or a scene content to be presented in the first frame.

The target pose of the user may be a pose that can determine a view angle of the electronic device for presenting the picture. Exemplarily, the target pose may be a pose (such as position and posture) of the head of the user.

A graphic processing system generally includes a central processing unit (CPU), a graphic processing unit (GPU), a display controller, a storage controller and a display. In response to that the central processing unit executes an application such as a game, the application submits instructions and data to a driver which is executed in the CPU and used in the GPU, then the driver generates instructions and data to enable the GPU to render frames for display and store the frames in a frame buffer, and these frames can be read into a buffer of the display by the display controller and finally displayed through a display panel of the display.

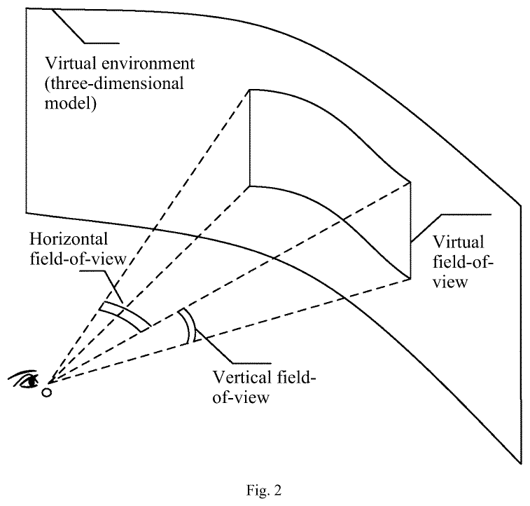

On this basis, sensors (such as nine-axis sensors) for posture detection are further arranged in some electronic devices (such as the extended reality device) and configured to detect the posture changes of the extended reality device in real time. If the user wears the extended reality device, in response to that the head posture of the user changes, a real-time posture of the head can be transmitted to the processor, then a fixation point of the line of sight of the user in an virtual environment is computed, an image within a fixation range (namely an virtual field-of-view) of the user in a three-dimensional model at the virtual environment is computed according to the fixation point and displayed on the display screen, and therefore the user feel like having an immersive experience of watching in a real environment. FIG. 2 shows an optional schematic diagram of a virtual field-of-view of an extended reality device provided by an embodiment of the present disclosure; a distribution range of the virtual field-of-view in the virtual environment is described with a horizontal field-of-view angle and a vertical field-of-view angle; the distribution range in a vertical direction is represented by the vertical field-of-view angle (BOC); the distribution range in a horizontal direction is represented by the horizontal field-of-view angle (AOB); human eyes can always perceive an image located in the virtual field-of-view at the virtual environment through a lens, and it may be understood that a larger the field-of-view angle is, a larger the size of the virtual field-of-view is, and a larger the area of the virtual environment perceived by the user is. The field-of-view angle represents the distribution range of the view angle in perceiving the environment through the lens. For example, the field-of-view angle of the extended reality device represents the distribution range of the view angle of the human eyes in perceiving the virtual environment through the lens of the extended reality device; and for another example, for a mobile terminal provided with a camera, the field-of-view angle of the camera is the distribution range of the view angle of the camera perceiving the real environment for shooting.

In some specific embodiments, determining firstly whether a change of a current head pose of the user relative to the head pose adopted in rendering of the previous frame is small enough for rendering the first frame (for example, whether it is smaller than a threshold), and in response to yes, whether the current scene content is unchanged relative to the scene content of the previous frame can be further determined. In other specific embodiments, whether the current scene content is unchanged relative to the scene content of the previous frame can be determined firstly, and in response to yes, whether the change of the current head pose of the user relative to the head pose adopted in rendering of the previous frame is small enough can be further determined (for example, whether the change is smaller than the threshold).

In some embodiments, whether the scene content is changed can be determined through interaction device data (such as handle data and gesture data), animations in the scene and the like. A n interaction device includes a man-machine interaction device configured to achieve communication or interaction between the user and the electronic device or a body part (such as hands and eyes) of the user. The man-machine interaction device includes but is not limited to a handle, a joystick, a steering wheel, a mouse, a keyboard, a trackball and the like. Exemplarily, a coordinate value of the handle, a button pressing status, a trigger activity or a gesture can be read to identify whether the user performs actions such as object grabbing, door opening, and shooting, and then whether there is corresponding response or change in the scene can be determined. In some embodiments, even if new interaction device data or events are detected, in response to that the scene content is unaffected (for example, the interaction device is not in the virtual field-of-view of the current user), it is not determined that the scene content is changed.

In some embodiments, the extended reality device (such as a head-mounted display (HMD)) is integrated with a hand tracking device through which the hand information of the user, such as a user gesture, can be acquired. The hand tracking device is a part of the HMD (such as being embedded into or attached to the head-mounted device).

In some embodiments, the hand tracking device includes an image sensor (such as one or more infrared cameras, 3D cameras, depth cameras and/or color cameras) for capturing three-dimensional scene information including at least the hand of the human user. The image sensor captures a hand image with a sufficient resolution, so that the fingers and the corresponding positions thereof can be distinguished.

In some embodiments, the extended reality device is integrated with a gaze tracking device through which visual information of the user, such as the line of sight and the gaze point of the user, can be acquired. In one embodiment, the gaze tracking device includes at least one eye tracking camera (such as an infrared (IR) or near-infrared (NIR) camera), and an illumination source (such as an infrared or near-infrared light source like an array or a ring of LEDs) that can emit light (such as infrared or near-infrared light) towards the eye of the user. The eye tracking camera can point to the eye of the user to receive the infrared or near-infrared light that is directly reflected by the eye the light source from the light source, or alternatively point to “heat” mirrors located between the eye of the user and the display panel, and the heat mirrors can reflect the infrared or near-infrared light from the eye to the eye tracking camera and allow visible light to pass through at the same time. The gaze tracking device optionally captures images of the eye of the user (such as a video stream captured at 60-120 frames per second (fps)), analyzes the images to generate gaze tracking information and transmits the gaze tracking information to the extended reality device, and therefore some human-computer interaction functions can be implemented based on the gaze information of the user, such as content navigation based on the gaze information. In some embodiments, the eyes of the user are independently tracked through the corresponding eye tracking camera and the illumination source. In some embodiments, only one eye of the user is tracked through the corresponding eye tracking camera and the illumination source.

In some specific embodiments, a corresponding threshold can be set for the interaction device data to determine whether scene content is changed, for example, in response to that the change of the interaction device data is larger than the threshold, it is determined that the scene content is changed.

Animation presented by the application is controllable and perceived for the application, and therefore whether the scene content is changed can be determined by further combining whether the animation presented in the application is changed in the embodiment.

Step S120: in response to determining that the preset condition is met, skipping rendering the first frame, and performing transformation processing on the previous frame based on an updated target pose to obtain an output frame for display.

In the embodiment, it is determined that the preset condition is met for rendering a first frame, don't render the first frame, the previous frame (old frame) of the first frame is used, specifically, based on a difference between the updated target pose and the target pose corresponding to the previous frame, the previous frame is subjected to transformation processing (such as twisting and deflection) to obtain the output frame, and the output frame can replace the first frame to be displayed in the screen.

In some embodiments, the updated target pose includes a target pose actually sensed latest or a predicted target pose based on a sensing device, for example, the user head pose in actual display of the output frame can be predicted based on the actually sensed user head pose.

In some embodiments, the previous frame can be subjected to transformation processing based on the updated target pose through time warp/time warping (also called reprojection). The time warp/time warping or reprojection is an image frame correction technology; the flow and time from image rendering to display are relatively long, so the user head posture in rendering of each frame of image may be different from the user head posture in final display; the time warp/time warping is to warp the rendered image based on the updated user head pose before the rendered image is transmitted to the display, thus error caused by the movement of the user head after the image is rendered is corrected, and the image viewed by the user is ensured to be matched with the actual head position. In some specific embodiments, the time warp/time warping includes but is not limited to asynchronous time warp (ATW), asynchronous space warp (ASW) or positional time warp (PTW) and the like.

Step S130: displaying the output frame through a display generation component.

In some specific embodiments, it is determined that preset condition is met for rendering the i^{th} frame by the application, the application can notify a drawing and screen displaying component (such as runtime) to skip or discard the i^{th} frame through a preset interface. After the drawing and screen displaying component receives the notification, this frame of image can be not updated into a frame buffer (such as a swap chain) to be prepared for display, and the rendered (i−1)^{th} frame can be processed and displayed in the screen by adopting the time warp/time warping technology.

According to one or more embodiments of the present disclosure, the method includes:
determining whether the preset condition is met for rendering the current frame, in which, the preset condition includes that the change of the current target pose of the user relative to the target pose corresponding to the previous frame of the first frame is smaller than the threshold, and the current scene content is unchanged relative to the scene content corresponding to the previous frame; in response to determining that the preset condition is met, skipping rendering the first frame, and performing transformation processing on the previous frame based on the updated target pose to obtain the frame of image to be displayed in the screen currently; therefore, it is not needed to render the current frame, the computation resources for rendering can be reduced, the power consumption can be reduced, and the endurance of the device can be prolonged. Particularly, in some use scenes such as viewing the text and picture by the user, the user often remains stationary or has little amplitude of motion, and the rendering power consumption can be greatly reduced by adopting the solution provided by the embodiment of the present disclosure.

In some embodiments, the preset condition further includes that a number of currently-rendered frames being greater than a preset threshold. In the embodiment, by setting the rendering number threshold the frames, that is, only in response to that the number of the rendered frames is greater than the threshold, the rendering of the current frame can be skipped, so that the initial rendering effect of the image is ensured.

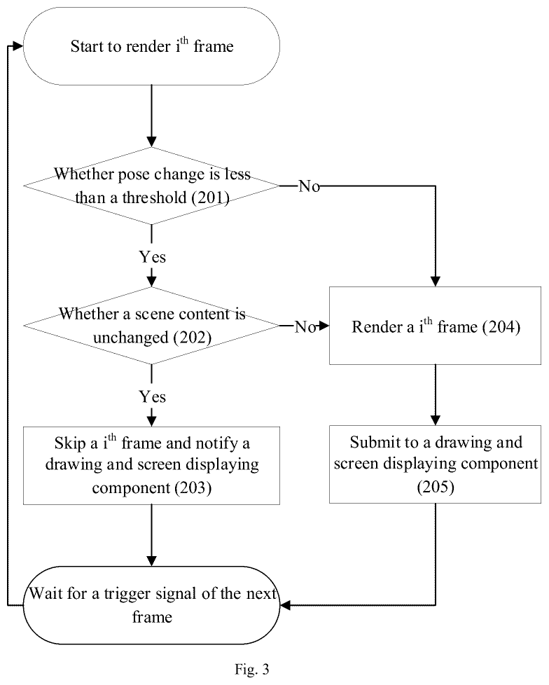

The steps executed on the application are exemplarily explained below. With reference to FIG. 3, it shows a flowchart of an image rendering method provided by one embodiment of the present disclosure, and the method includes:
Step 201: determining whether a pose change of a current head pose of a user relative to a head pose in the rendering of the (i−1)^{th} frame is smaller than a threshold for rendering the i^{th} frame;
In response to determining that the pose change is smaller than the threshold, executing step 202; and in response to determining that the pose change is not smaller than the threshold, executing steps 204-205.
Step 202: determining whether a current scene content is unchanged relative to a scene content corresponding to the (i−1)^{th} frame;
In response to being unchanged, executing step 203: skipping a rendering process for the i^{th} frame, and notifying a drawing and screen displaying component to skip the i^{th} frame.

In response to being changed, executing steps 204-205.
Step 204: rendering the i^{th} frame with an application.
Step 205: submitting the rendered i^{th} frame to the drawing and screen displaying component through the application.

Finally, the application waits for a trigger signal of the next frame ((i+1)^{th} frame), and executes the above process on the next frame, and the process is repeated in such a way.

Correspondingly, after the drawing and screen displaying component receives the notification of the application, the updating of frames in the frame buffer (such as swap chain) is not carried out any more, the time warp/time warping technology is adopted for carrying out transformation processing on the rendered (i−1)^{th} frame to obtain the output frame, and the output frame is used for replacing the i^{th} frame to be displayed in the screen.

In some embodiments, a first renderer can be predefined, and the first renderer is configured as default not to render one or more objects. For example, the first renderer does not perform rendering processing on rendering objects such as a skybox, a 3D model, a particle effect, a line, a trailing effect or terrain by default. Therefore, the first renderer can be adopted to process the first frame so as to skip rendering the first frame, and an original rendering process is not greatly changed.

In some embodiments, in response to that it is needed to skip rendering the first frame, a buffer (such as a color buffer, a depth buffer and a template buffer) of a camera component is not cleaned. In the embodiment, the buffer of the camera component is not cleaned during skipping rendering the first frame, so that the information of the previous frame can be reserved, and the rendering power consumption is reduced. Exemplarily, the attribute (such as clear flags attribute) of the camera component can be set, so that the buffer of the camera component is not cleaned during skipping rendering the first frame, but the present disclosure is not limited to this.

In some embodiments, the first frame may be ignored or a weight of the first frame may be reduced in statistics of rendering time consumption, so that a situation that extra buffer time is increased because a synchronization mechanism component mistakenly determines that the time consumption fluctuation of a client is relatively large due to special processing on the first frame in the embodiment is avoided, the stable minimum perceptible delay can be kept, and the user experience can be optimized. The statistics of rendering time consumption may include statistics of CPU time consumption and GPU time consumption.

In some embodiments, the first frame may be ignored or a weight of the first frame may be reduced in lost frame statistics, thus the interference on hardware resource scheduling caused by misjudgment on insufficient performance of the system due to loss of the first frame (namely skipping rendering the first frame) in the embodiment is prevented (for example, triggering of unnecessary CPU and GPU frequency rise is avoided), and more efficient and energy-saving hardware resource management can be realized.

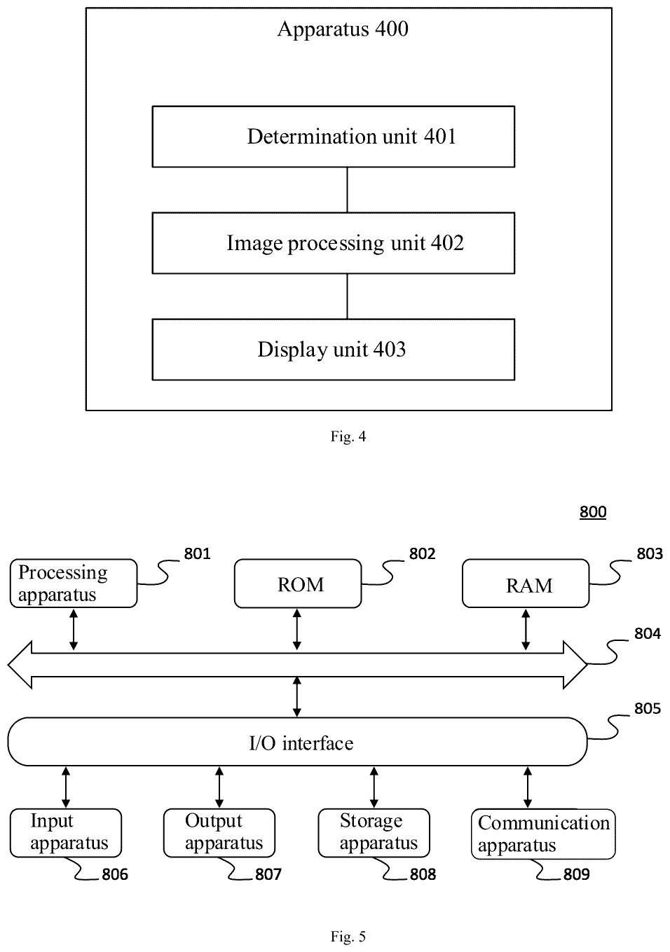

Correspondingly, with reference to FIG. 4, an embodiment of the present disclosure provides an image rendering apparatus 400, which includes:
a determination unit 401, configured to: determine whether a preset condition is met for rendering a first frame, in which, the preset condition includes that a change of a current target pose of a user relative to a target pose corresponding to a previous frame of the first frame is smaller than a threshold, and a current scene content is unchanged relative to a corresponding scene content of the previous frame;
an image processing unit 402, configured to: in response to determining that the preset condition is met, skip rendering the first frame, and perform transformation processing on the previous frame based on an updated target pose to obtain an output frame for display; and
a display unit 403, configured to display the output frame through the display generation component.

In some embodiments, the preset condition further includes: a number of currently-rendered frames being greater than a rendering number threshold.

In some embodiments, skipping rendering the first frame, includes: processing the first frame using a first renderer that is preset; and the first renderer is configured as default not to render one or more rendering objects.

In some embodiments, skipping rendering the first frame, includes: skipping cleaning a buffer of a camera component.

In some embodiments, the apparatus further includes:
a first statistic unit, configured to ignore the first frame or reduce a weight of the first frame in statistics of rendering time consumption.

In some embodiments, the apparatus further includes:
a second statistic unit, configured to ignore the first frame or reduce a weight of the first frame in lost frame statistics.

In some embodiments, performing transformation processing on the previous frame based on the updated target pose, includes: performing, through time warp, transformation processing on the previous frame based on the updated target pose; and the time warp includes asynchronous time warp, asynchronous space warp or positional time warp.

For the embodiment of the apparatus, because it basically corresponds to the method embodiment, relevant parts may be referred to part of the description in the method embodiment. The apparatus embodiments described above are only schematic, and modules described therein as descriptions of isolation modules may or may not be separated. Some or all of the modules can be selected according to actual needs to realize the purpose of the solution of the present embodiment. Those of ordinary skill in the art may understand and implement it without creative effort.

Correspondingly, according to one or more embodiments of the present disclosure, an electronic device is provided and includes:
at least one memory and at least one processor;
the memory is configured to store program instructions; and the program instructions, when executed by the processor, cause the processor to execute the method provided by one or more embodiments of the present disclosure.

Correspondingly, according to one or more embodiments of the present disclosure, a non-transitory computer-readable storage medium is provided; the non-transitory computer-readable storage medium is configured to store program instructions, and the program instructions, when executed by a processor, cause the processor to execute the image rendering method provided by one or more embodiments of the present disclosure.

With reference to FIG. 5 below, it is a structure schematic diagram of an electronic device 800 suitable for implementing the embodiment of the present disclosure. The electronic device illustrated by FIG. 5 is only an example, and does not bring any limitation to the functions and the use range of the embodiment of the present disclosure.

A s illustrated by FIG. 5, the electronic device 800 can include a processing apparatus (such as a central processing unit, a graphic processing unit) 801, which can perform various appropriate actions and processing according to a program stored in a read-only memory (ROM) 802 or a program loaded from a storage apparatus 808 to a Random Access Memory (RAM) 803. In the RAM 803, various programs and data required for operation of the electronic device 800 are also stored. The processing apparatus 801, ROM 802 and RAM 803 are connected to one another through a bus 804. An input/output (I/O) interface 805 is also connected to the bus 804.

Typically, the following apparatuses may be connected to the I/O interface 805: an input apparatus 806 such as a touch screen, a touchpad, a keyboard, a mouse, a camera, a microphone, an accelerometer, and a gyroscope; an output apparatus 807 such as a liquid crystal display (LCD), a loudspeaker, and a vibrator; a storage apparatus 808 such as a magnetic tape, and a hard disk drive; and a communication apparatus 809. The communication apparatus 809 may allow the electronic device 800 to wireless-communicate or wire-communicate with other devices so as to exchange data. Although FIG. 5 shows the electronic device 800 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program instruction for executing the method shown in the flow diagram. In such an embodiment, the computer program may be downloaded and installed from the network by the communication apparatus 809, or installed from the storage apparatus 808, or installed from ROM 802. When the computer program is executed by the processing apparatus 801, the above functions defined in the method in the embodiments of the present disclosure are executed.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. M ore specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program instruction. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program instruction contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a Hypertext Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device performs the method of the present disclosure described above.

The computer program instructions for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program instruction may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of instructions, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. M ore specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, there is provided an image rendering method, including: determining whether a preset condition is met for rendering a first frame, wherein the preset condition includes that a change of a current target pose of a user relative to a target pose corresponding to a previous frame of the first frame is smaller than a threshold, and a current scene content is unchanged relative to a scene content corresponding to the previous frame; in response to determining that the preset condition is met, skipping rendering the first frame, and performing transformation processing on the previous frame based on an updated target pose to obtain an output frame for display; displaying the output frame through the display generation component.

According to one or more embodiments of the present disclosure, the preset condition further includes: a number of currently-rendered frames being greater than a rendering number threshold.

According to one or more embodiments of the present disclosure, the method further including: presetting a first renderer, wherein the first renderer is configured as default not to render one or more rendering objects; and skipping rendering the first frame, includes: processing the first frame using the first renderer.

According to one or more embodiments of the present disclosure, skipping rendering the first frame, includes: skipping cleaning a buffer of a camera component.

According to one or more embodiments of the present disclosure, the method further including: ignoring the first frame or reducing a weight of the first frame in statistics of rendering time consumption.

According to one or more embodiments of the present disclosure, the method further including: ignoring the first frame or reducing a weight of the first frame in lost frame statistics.

According to one or more embodiments of the present disclosure, performing transformation processing on the previous frame based on the updated target pose, includes: performing, through time warp, transformation processing on the previous frame based on the updated target pose, wherein the time warp includes asynchronous time warp, asynchronous space warp or positional time warp.

According to one or more embodiments of the present disclosure, there is provided an image rendering apparatus, including: a determination unit, configured to: determine whether a preset condition is met for rendering a first frame, wherein the preset condition includes that a change of a current target pose of a user relative to a target pose corresponding to a previous frame of the first frame is smaller than a threshold, and a current scene content is unchanged relative to a scene content corresponding to the previous frame; an image processing unit, configured to: in response to determining that the preset condition is met, skip rendering the first frame, and performing transformation processing on the previous frame based on an updated target pose to obtain an output frame for display; a display unit, configured to display the output frame through an display generation component.

According to one or more embodiments of the present disclosure, there is provided an electronic device, including: at least one memory and at least one processor, wherein the memory is configured to store program instructions; and the program instructions, when executed by the processor, cause the processor to execute the image rendering method according to one or more embodiments of the present disclosure.

According to one or more embodiments of the present disclosure, there is provided a non-transitory computer-readable storage medium, including: wherein the non-transitory computer-readable storage medium is configured to store program instructions, and the program instructions, when executed by a processor, cause the processor to execute the image rendering method according to one or more embodiments of the present disclosure through the electronic device.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An image rendering method, comprising:
determining whether a preset condition is met for rendering a first frame, wherein the preset condition comprises that a change of a current target pose of a user relative to a target pose corresponding to a previous frame of the first frame is smaller than a threshold, and that a current scene content is unchanged relative to a scene content corresponding to the previous frame;
in response to determining that the preset condition is met, skipping rendering the first frame, and performing transformation processing on the previous frame based on an updated target pose to obtain an output frame for display; and
displaying the output frame through a display generation component.

2. The method according to claim 1, wherein the preset condition further comprises: a number of currently-rendered frames being greater than a preset rendering number threshold.

3. The method according to claim 1, further comprising: presetting a first renderer,
wherein the first renderer is configured as default not to render one or more rendering objects; and
skipping rendering the first frame, comprises: processing the first frame using the first renderer.

4. The method according to claim 1, wherein skipping rendering the first frame, comprises: skipping cleaning a buffer of a camera component.

5. The method according to claim 1, further comprising: ignoring the first frame or reducing a weight of the first frame in statistics of rendering time consumption.

6. The method according to claim 1, further comprising: ignoring the first frame or reducing a weight of the first frame in lost frame statistics.

7. The method according to claim 1, wherein performing the transformation processing on the previous frame based on the updated target pose, comprises:
performing, through time warp, transformation processing on the previous frame based on the updated target pose, wherein the time warp comprises asynchronous time warp, asynchronous space warp or positional time warp.

8. An electronic device, comprising:
at least one memory and at least one processor,
wherein the memory is configured to store program instructions, and the program instructions, when executed by the processor, cause the processor to execute an image rendering method, wherein the image rendering method comprises:
determining whether a preset condition is met for rendering a first frame, wherein the preset condition comprises that a change of a current target pose of a user relative to a target pose corresponding to a previous frame of the first frame is smaller than a threshold, and that a current scene content is unchanged relative to a scene content corresponding to the previous frame;
in response to determining that the preset condition is met, skipping rendering the first frame, and performing transformation processing on the previous frame based on an updated target pose to obtain an output frame for display; and
displaying the output frame through a display generation component.

9. The electronic device according to claim 8, wherein the preset condition further comprises: a number of currently-rendered frames being greater than a rendering number threshold.

10. The electronic device according to claim 8, wherein the method further comprises:
presetting a first renderer, wherein the first renderer is configured as default not to render one or more rendering objects; and
skipping rendering the first frame, comprises: processing the first frame using the first renderer.

11. The electronic device according to claim 8, wherein skipping rendering the first frame, comprises:
skipping cleaning a buffer of a camera component.

12. The electronic device according to claim 8, wherein the method further comprises: ignoring the first frame or reducing a weight of the first frame in statistics of rendering time consumption.

13. The electronic device according to claim 8, wherein the method further comprises: ignoring the first frame or reducing a weight of the first frame in lost frame statistics.

14. The electronic device according to claim 8, wherein performing transformation processing on the previous frame based on the updated target pose, comprises:
performing, through time warp, transformation processing on the previous frame based on the updated target pose, wherein the time warp comprises asynchronous time warp, asynchronous space warp or positional time warp.

15. A non-transitory computer-readable storage medium,
wherein the non-transitory computer-readable storage medium is configured to store program instructions, and the program instructions, when executed by a processor, cause the processor to execute an image rendering method, wherein the image rendering method comprises:
determining whether a preset condition is met for rendering a first frame, wherein the preset condition comprises that a change of a current target pose of a user relative to a target pose corresponding to a previous frame of the first frame is smaller than a threshold, and that a current scene content is unchanged relative to a scene content corresponding to the previous frame;
in response to determining that the preset condition is met, skipping rendering the first frame, and performing transformation processing on the previous frame based on an updated target pose to obtain an output frame for display; and
displaying the output frame through a display generation component.

16. The electronic device according to claim 15, wherein the preset condition further comprises: a number of currently-rendered frames being greater than a rendering number threshold.

17. The electronic device according to claim 15, wherein the method further comprises:
presetting a first renderer, wherein the first renderer is configured as default not to render one or more rendering objects; and
skipping rendering the first frame, comprises: processing the first frame using the first renderer.

18. The electronic device according to claim 15, wherein skipping rendering the first frame, comprises:
skipping cleaning a buffer of a camera component.

19. The electronic device according to claim 15, wherein the method further comprises: ignoring the first frame or reducing a weight of the first frame in statistics of rendering time consumption.

20. The electronic device according to claim 15, wherein the method further comprises: ignoring the first frame or reducing a weight of the first frame in lost frame statistics.
